(19) United States
(12) Patent Application Publication
(10) Pub. No.: US 2003/0198224 A1
(43) Pub. Date: Oct. 23, 2003

(54) Method for filtering packets and associated controller

(75) Inventors: Benjamin Lee, Taipei (TW); Aj Jiang, Taipei (TW); Tevin Chen, Taipei (TW)

Correspondence Address: BRUCE H. TROXELL, 5205 LEESBURG PIKE, SUITE 1404, FALLS CHURCH, VA, 22041, US

(73) Assignee: VIA TECHNOLOGIES, INC.

(21) Appl. No.: 10/369,640

(22) Filed: Feb. 21, 2003

(30) Foreign Application Priority Data
Apr. 23, 2002 (TW) 91108289

(51) Int. Cl. H04L 12/28

(52) U.S. Cl. 370/392; 370/252

(57) ABSTRACT

The present invention discloses a method and an associated controller for filtering packets. The controller is capable of filtering a plurality of multicast packets. The controller comprises: a content addressable memory control circuit for identifying the packets; a receive buffer; and a FIFO (first-in-first-out) buffer.

### BACKGROUND OF THE INVENTION

1. Field of the Invention

The present invention generally relates to a method and an associated controller for filtering packets and, more particularly to a network interface card employed in the network system so as to filter a plurality of multicast packets by programming a content addressable memory.

2. Description of the Prior Art

With the high development and diverse applications on the Internet, the modern-day people have increasing needs for a higher operation speed as well as a higher data transmission rate on the network. Therefore, the performance of hardware and software becomes more critical than ever. In general, hardware devices such as switches, hubs, bridges, repeaters and routers are employed in a network system so as to interconnect the subscriber's end and the service end through transmission lines. To transmit various forms of data over a complex network system, lots of standards are provided to stipulate the formats for data transmission. These standards include, for examples, TCP (transmission control protocol), IP (Internet protocol), IGMP (Internet group management protocol), GARP (generic attribute registration protocol), and GVRP (GARP VLAN registration protocol).

Typically, there are three types of packets: the broadcast packet, the multicast packet, and the unicast packet. The corresponding addresses on the network can also be classified into three types: the broadcast address, the multicast address, and the unicast address. For a unicast address, the packet is transmitted from a source to a destination. On the Internet, each computer has at least one unicast address. All the unicast addresses can be grouped into Level A, Level B, or Level C in IP addressing. For a broadcast address, the packet is transmitted from a source to several undetermined destinations. For a multicast address, however, the packet is transmitted from a source to several determined destinations. The addresses of these determined destinations can be categorized into one group. Therefore, these addresses are referred to as a group address, which are assigned into Level D in IP addressing.

Please refer to FIG. 1, which is a functional diagram in which a hash function is used to process a multicast packet. The hash function generates hash values to map multicast addresses onto memory addresses. For example, for an MAC (media access control) address, a network IC (NIC) generates a 6-bit mapping value through the hash function. The 3 MSBs (most significant bits), as shown in the MSB field 15 in FIG. 1, of these 6 bits can be used to select a byte among the 8 bytes in a multicast group table 13. However, the 3 LSBs (least significant bits), as shown in the LSB field 16 in FIG. 1, of these 6 bits can be used to select a bit among the 8 bits of the selected byte, namely, one bit from A₀ to A₇. As shown in FIG. 1, the media access control address contains 48 bits. Therefore, each 48-bit destination address for multicast can proceed with operation by CRC 32 so as to generate a 32-bit value. The higher 6 bits are mapped onto the 64-bit multicast group table 13, which can be stored in an 8×8-bit memory. Then filtering is performed by using a mapped bit “0” or “1” so as to determine whether the network interface card should receive the packet with such a destination MAC address. More particularly, if the mapped bit is “1”, the packet is received.

However, such an addressing method by using a hash function has a problem that, under some circumstances, a plurality of multicast packets may be mapped onto the same target bit on the multicast group table by the device 10. When the target bit is found, an entry is hit. However, sometimes a plurality of multicast packet addresses may hit the same entry due to the calculation of hash function. This is referred to as imperfect match. More specifically, for example, a multicast packet A 11 is one to be selected, while another multicast packet B 12 is not. However, the multicast packets A 11 and B 12 may be mapped onto the same position due to hash function calculation. Meanwhile, the NIC will receive both of the multicast packets A 11 and B 12. The multicast packet B 12 will then be dropped after being processed through a higher level protocol. The multicast packets B 12 is referred to as a dummy packet. In this case, a larger buffer memory is required and the time for processing the multicast packets B 12 wastes the system source, thus degrading the performance of the entire system.

Therefore, there is need for selecting a plurality of interesting packets without generating dummy packets.

### SUMMARY OF THE INVENTION

In view of the above problems, accordingly, it is the primary object of the present invention to provide a method and a device for filtering packets, in which interesting packet addresses are programmed into a network interface card for filtering selecting and transmitting multicast packets so as to achieve efficient perfect match.

It is another object of the present invention to provide a content addressable memory comprising an address portion for interesting packets and an address portion for general packets so as to store the destination addresses of interesting packets into the content addressable memory and identify whether a received packet is an interesting packet.

In order to achieve the foregoing object, the present invention provides a circuit, which can be implemented in a network interface card or a south bridge chip, comprising: a content addressable memory control circuit for identifying a packet; a receive buffer; and a FIFO (first-in-first-out) buffer. The content addressable memory comprises an address portion for interesting packets and an address portion for general packets.

Moreover, the present invention also provides a method for initializing a network interface card, comprising steps of:

a. initializing a network interface card;

b. arranging the content of a content addressable memory;

c. writing a plurality of MAC addresses into the content addressable memory according to the arrangement; and

d. activating the network interface card so as to transceive packets.

Furthermore, the present invention also provides a method for identifying a packet, comprising steps of:

a. receiving a packet by a network interface card;

b. comparing the received packet so as to determine whether it is an interesting packet in view of a content addressable memory; and

c. transmitting said received packet to a software application for further processing.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits and advantages of the preferred embodiments of the present invention will be readily understood by the accompanying drawings and detailed descriptions, wherein:

FIG. 1 is a conventional functional diagram in which a hash function is used to process a multicast packet in accordance with the prior art;

FIG. 2 is a schematic block diagram configuring a content addressable memory in accordance with the present invention;

FIG. 3 is a schematic block diagram showing the circuitry in accordance with the present invention;

FIG. 4 is a schematic block diagram showing the receive descriptors in accordance with the present invention;

FIG. 5 is a schematic flow chart showing a method for initializing a network interface card in accordance with the present invention; and

FIG. 6 is a schematic flow chart showing a method for identifying a packet in accordance with the present invention.

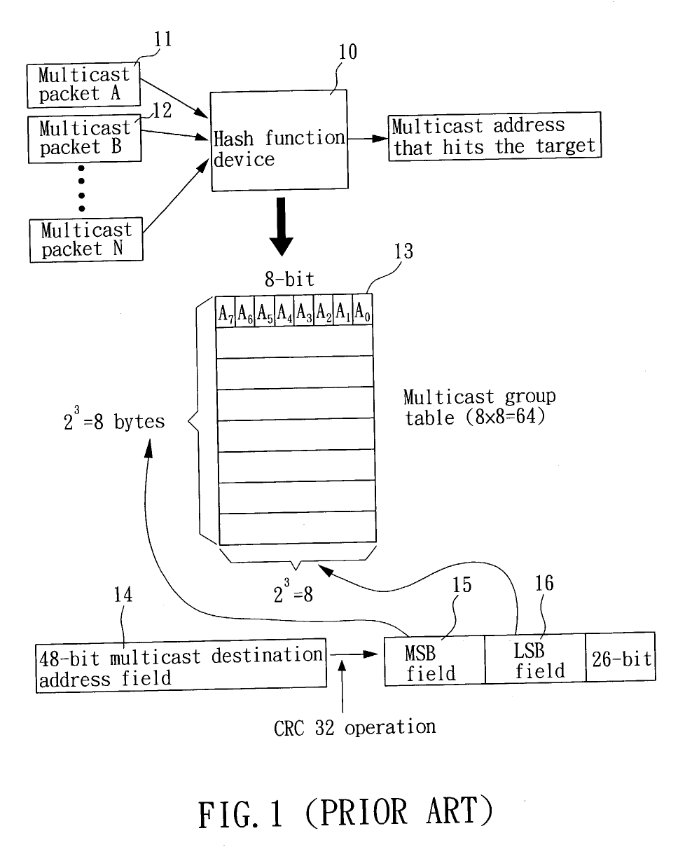

### DETAILED DESCRIPTION OF THE INVENTION

The present invention generally relates to a method and a device for filtering packets, wherein interesting packets are pre-determined. The present invention, however, is not limited to the multicast packet. A unicast packet and a broadcast packet can both be applied. The present invention also discloses a method for programming a content addressable memory. The present invention can be exemplified by the preferred embodiment as described hereinafter.

To begin with, interesting packets in the present invention represent a plurality of specific multicast packets to be selected. These interesting packets are determined according to users' requirement. Therefore, the interesting packets are various kinds, such as multicast packets or broadcast packets. In other words, the hardware devices utilized in the present invention can not only process multicast packets, but also process multicast packets or broadcast packets.

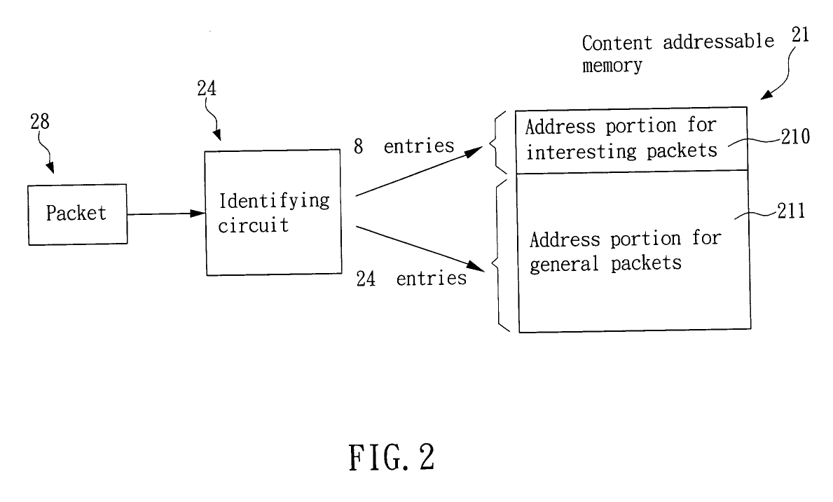

Please refer to FIG. 2, which is a schematic block diagram showing the programming of a content addressable memory (CAM) in accordance with the present invention. The content addressable memory is a memory device used for storing information such as addresses and calculation results. As shown in FIG. 2, the content addressable memory 21 is configured as two portions: an address portion for interesting packets 210, for storing interesting packet addresses; and an address portion for general packets 211, for storing general packet addresses. If the content addressable memory 21 includes 32 entries, in this embodiment, the address portion for interesting packets 210 and the address portion for general packets 211 can be configured as 8 entries and 24 entries, respectively. The content addressable memory 21 stores the addresses of the interesting packets, and an identifying circuit 24 compares the DMAC address of an incoming packet 28 with the addresses stored in the content addressable memory 21. If the DMAC address matches any address in the CAM 21, a perfectly matched result is obtained.

Moreover, in view of the operation flow for receiving a packet by a network interface card, the network interface card identifies the addresses of the 8 entries stored in the address portion for interesting packets of the content addressable memory, so as to determine whether the received packet is an interesting packet. If the received packet is an interesting packet, the received packet is temporally stored in a host memory for subsequently processing. If the received packet is not an interesting packet, the 24 entries stored in the address portion for general packets 211 are compared. In practical operation, the DMAC address of the incoming packet is fetched and compared to all the entries simultaneously. Within a hardware cycle time, the network interface card can provide the comparison result. In this manner, it only takes little time to complete the operation. On the contrary, the prior art receives lots of imperfectly matched packets into the host memory, which are dropped after being examined by upper layer applications. Accordingly, the present invention can effectively reduce the time for processing the incoming packets and relief the load of hardware/software.

In one preferred embodiment of the present invention, when the received packet is an interesting packet with a DMAC address which is a multicast address, preferably, 01-80-C2-00-00-21 according to GVRP, perfect match occurs by comparing the interesting packet addresses stored in the content addressable memory shown in FIG. 2. Before the network interface card actuates this function, a driver of the network interface card should configure the content addressable memory on the network interface card, so as to program a plurality of addresses of the interesting packets into the content addressable memory. Therefore, when the network interface card receives a packet, the driver can determine whether the received packet is an interesting packet according to an interesting packet field (IPKT) in a corresponding receive descriptor.

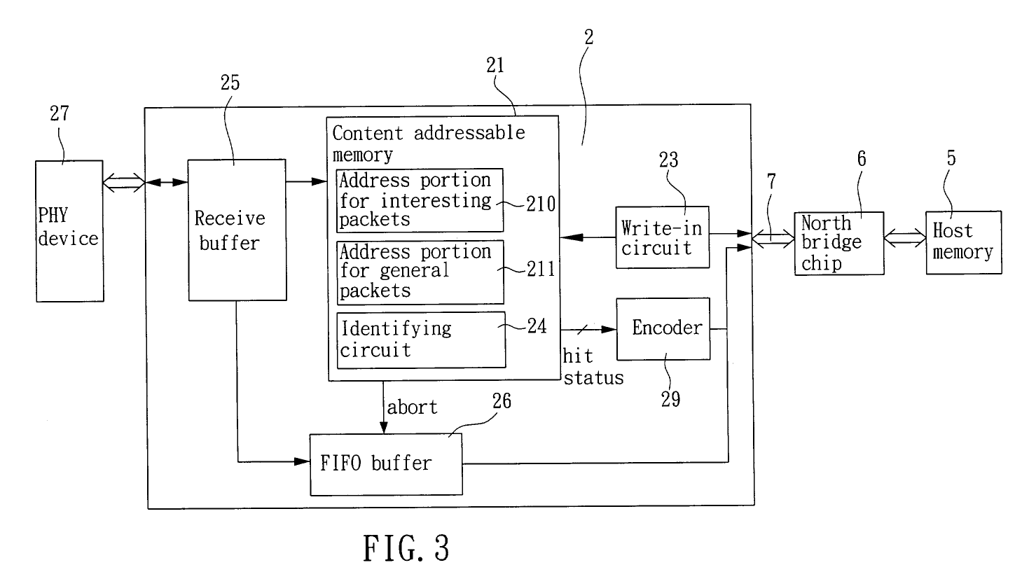

Please refer to FIG. 3, which is a schematic block diagram in accordance with the present invention. In the figure, an network interface card comprises a physical layer (PHY) device 27 and a media access control (MAC) controller 2. The MAC controller 2 comprises: at least a content addressable memory 21, a packet receive buffer 25, a write-in circuit 23, a receive first-in-first-out (Rx FIFO) buffer 26 and an encoder 29. The content addressable memory 21 comprises an identifying circuit 24.

As shown in FIG. 2, the content addressable memory 21 comprises: an address portion for interesting packets 210; and an address portion for general packets 211. The address portion for interesting packets 210 is used for storing pre-determined interesting packet addresses. The address portion for general packets 211 is used for storing general packet addresses. If the content addressable memory 21 includes 32 entries, in this embodiment, the address portion for interesting packets 210 can be programmed to have 8 entries and the address portion for general packets 211 can be programmed to have 24 entries. In FIG. 3, when a packet is incoming into the physical layer device 27, a plurality of bits of the packet are real-time temporally stored in the packet receive buffer 25 and then transmitted into the Rx FIFO buffer 26. The packet receive buffer 25 is preferably implanted as a 48-bit buffer, so as to fetch the DMAC address of the packet. The capacity of the Rx FIFO buffer 26 is about 2K bytes, which is larger than the maximum Ethernet packet so as to buffer the current whole packet. After the 48-bit DMAC address is buffered in the packet receive buffer 25, the identifying circuit 24 in the content addressable memory 21 compares the 48-bit DMAC address with the address portion for interesting packets 210 and the address portion for general packets 211. If the 48-bit DMAC address is different from the address portion for interesting packets 210 and the address portion for general packets 211, an abort signal is asserted so that the FIFO buffer 26 drops the packet currently stored. On the contrary, however, if, after the comparison made by the identifying circuit 24 in the content addressable memory 21, it is determined that the packet currently stored in the FIFO buffer 26 is exactly the packet that should be received by the network interface card, the packet will be transmitted through the PCI bus 7 to the north bridge chip 6 and then stored in the host memory 5. Those who are skilled in this art should note that the path in which the packet is stored into the host memory 5 can be also implemented by using a high speed bus exclusively for interconnection between a north bridge chip and a south bridge chip, for example, VLINK bus from VIA. Next, the identifying circuit 24 in the content addressable memory 21 generates a hit status signal that will generate a corresponding Rx descriptor in the host memory 5 through an encoder 29 (though it may not be encoded). For example, if the hit status signal shows that the current packet is an interesting packet, the interesting packet field (IPKT) in a corresponding receive descriptor will be updated. Preferably, the address portion for interesting packets 210 of the content addressable memory 21 can be configured to have 8 interesting packet addresses and the address portion for general packets 211 can be configured to have multicast addresses. Multicast addresses are useful in the process of mass data such as video information and audio information. If the content addressable memory 21 does not provide any perfect match for the packet, the packet can be further filtered by the buffer 25 through a hash table (not shown). A signal generated by using the hash table and the content addressable memory 21 then decides whether to drop the packet currently stored in the Rx FIFO buffer 26 or to transfer the packet into the host memory.

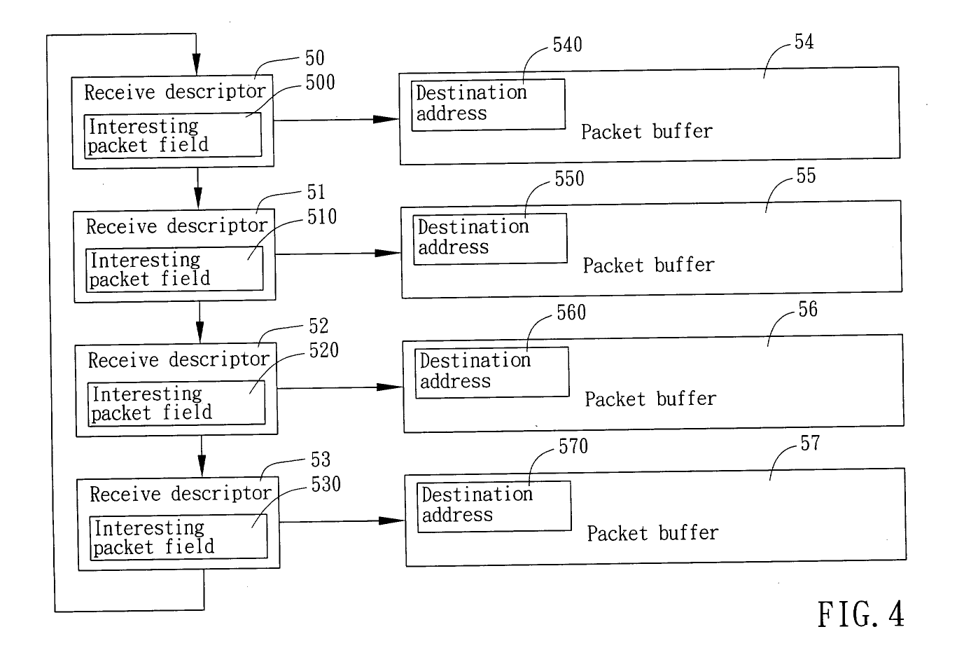

Please refer to FIG. 4, which is a schematic block diagram showing the receive descriptors in accordance with the present invention. As shown in FIG. 4, there are four receive descriptors 50, 51, 52, 53 and four packet buffers 54, 55, 56, 57. Each of the receive descriptors 50, 51, 52, 53 has an interesting packet field 500, 510, 520, 530. The interesting packet field is 8 bits in length. Such an 8-bit field corresponds to the comparison result of the eight entries specified by the address portion for interesting packets 210 of the content addressable memory 21. This shows that the receive descriptor of this embodiment is implemented by using a ring data structure.

When a driver processes the packets stored in sequence through receive descriptors from 50 to 53 in the host memory 5, only the interesting packets field 500, 510, 520, 530 need to be examined so as to identify whether the corresponding packet is an interesting packet or not. If the corresponding packet is an interesting packet, it is transmitted to the operating system (OS) or related applications for further processing. A plurality of packet buffers 54, 55, 56, 57 in the host memory are used to buffer the packets that the network interface card determines to receive by hardware. Each of the packet buffers has a capacity of 2K bytes and a destination address field (DMAC) 540, 550, 560 and 570 that records the destination address to be reached. When the hit status provided by the receive descriptors 50, 51, 52, 53 can not perfectly determine whether the packet is the packet that the network interface card should receive, the operating system (OS) or related applications compares the destination addresses 540, 550, 560 and 570 so as to determine whether the packet should be received. The receive descriptors 50, 51, 52, 53 and the packet buffers 54, 55, 56, 57 can be defined in the host memory 5 as shown in FIG. 3.

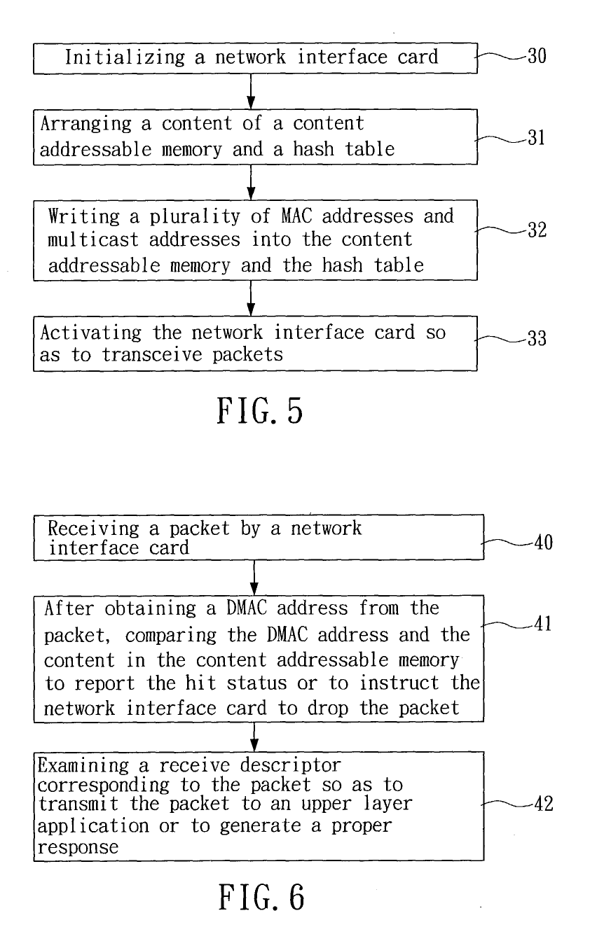

Please refer to FIG. 5, which is a schematic flow chart showing a method for initializing a network interface card in accordance with the present invention. With the hardware structures as shown in FIG. 2 and FIG. 3, a method for initializing a network interface card can be described to include the following steps:

a. initializing a network interface card (step 30);

b. arranging the content of a content addressable memory and a hash table (step 31);

c. writing a plurality of MAC addresses and multicast addresses into the content addressable memory and the hash table (step 32); and

d. activating the network interface card so as to receive and transmit packets (step 33).

More particularly, in step a, the initial settings of the network interface card are loaded from a non-volatile memory, such as an electrically erasable programmable read-only memory (EEPROM).

In step b, a driver arranges the interesting packet addresses and the multicast addresses provided through the operating system. For example, if the number of the interesting packet addresses and the multicast addresses transmitted from the operating system exceeds the number of the entries of the content addressable memory provided on a network interface card, the hash table can be determined based on the remaining packet addresses.

In step c, interesting packet addresses and general packet addresses are written in pre-determined order into a content addressable memory. The content addressable memory contains 32 entries, wherein 8 entries record the interesting packet addresses and the other 24 entries record the general packet addresses, for example, multicast addresses requiring real-time processing. More particularly, the addresses are written into the content addressable memory by using a write-in circuit 23 together with the settings of the write-in bits of the buffer so as to program of the content addressable memory. The general packet addresses, which the 24 entries record, have other applications. For example, the general packet addresses facilitate the users to define the packets to be filtered. After the entries recording DMAC addresses to be filtered are programmed into the content addressable memory, the hit status updates the contents in the corresponding receive descriptors and the driver identifies that the packets should be filtered. These packets are then dropped without being processed to an upper layer. Furthermore, the corresponding receive descriptors are correspondingly updated in response to comparing the content in the content addressable memory. In this manner, the driver can respond properly so as to set the function of the network interface card or to filter the packets.

Moreover, in step d, the network interface card is activated to transceive packets.

The fore-mentioned steps describe the procedure of processing packets and programming interesting packet addresses on the network interface card according to the present invention. Furthermore, how to identify a packet at the host side is described.

Please refer to FIG. 6, which is a schematic flow chart showing a method for identifying a packet in accordance with the present invention. The method comprises steps of:

a. receiving a packet by a network interface card (step 40);

b. after obtaining a DMAC address from the packet, comparing the DMAC address and the content in the content addressable memory to report the hit status or to instruct the network interface card to drop the packet (step 41); and

c. examining a receive descriptor corresponding to the packet so as to transmit the packet to an upper layer application or to generate a proper response (step 42).

More particularly, in step b, the DMAC address of the packet is obtained by the network interface card, and then the DMAC address and the content of the content addressable memory are compared so as to report the hit status or to make the network interface card drop the packet. When the network interface card identifies that the DMAC address of the packet has hit the content of the content addressable memory, the packet will be received, the associated receive descriptor is updated for an upper layer application.

Furthermore, after the comparison in step b, the hit status of the 8 entries of the address portion for interesting packets in the content addressable memory is provided to write into the interesting packet field in the receive descriptor.

The present invention successfully overcomes the problem of the conventional method in which the hash function can not precisely filter the determined packets. Please note that the method and the device according to the present invention can be employed in a network interface device together with the method for filtering packets by using a conventional hash function, so as to achieve the advantages of the present invention and to overcome the problems in the prior art.

The device as well as the method of the present invention can be implemented in a network device, such as a network interface card or a south bridge chip integrated with a media access control.

According to the above discussion, the present invention discloses a method and an associated controller for filtering packets, wherein a network interface card is capable of filtering a plurality of packets. Therefore, the present invention has been examined to be progressive, advantageous and applicable to the industry.

Although this invention has been disclosed and illustrated with reference to the above embodiments, the principles involved are susceptible for use in numerous other embodiments that will be apparent to persons skilled in the art. This invention is, therefore, to be limited only as indicated by the scope of the appended claims.

What is claimed is:

1. A method for filtering packets, comprising steps of:
initializing a network device;
arranging a content for a content addressable memory;
writing a plurality of pre-determined MAC addresses into said content addressable memory according to said content; and
activating said network device so as to transceive packets.

2. The method for filtering packets as recited in claim 1, wherein said initializing step comprises loading initial values of said network device from a non-volatile memory.

3. The method for filtering packets as recited in claim 1, wherein said arranging step comprising pre-determining a plurality of interesting packet addresses and a plurality of multicast addresses transmitted from an operating system (OS) to a driver in said network device.

4. The method for filtering packets as recited in claim 3, wherein said content addressable memory comprises an address portion for interesting packets and an address portion for general packets, wherein said address portion for interesting packets is used for storing said plurality of interesting packet addresses and said address portion for general packets is used for storing said plurality of multicast addresses.

5. The method for filtering packets as recited in claim 3, wherein said address portion for interesting packets comprises 8 entries.

6. The method for filtering packets as recited in claim 3, wherein said step of writing said plurality of pre-determined MAC addresses into said content addressable memory comprising writing said plurality of interesting packet addresses and said plurality of multicast addresses into said address portion for interesting packets and said address portion for general packets, respectively.

7. A method for filtering a packet, comprising steps of:
receiving said packet;
comparing a destination address of said received packet with a content of a content addressable memory; and
selectively dropping said packet in response to said comparison.

8. The method for filtering packets as recited in claim 7, wherein said content addressable memory comprises an address portion for interesting packets and an address portion for general packets, wherein said address portion for interesting packets is used for storing said plurality of interesting packet addresses and said address portion for general packets is used for storing said plurality of multicast addresses.

9. The method for filtering packets as recited in claim 7, wherein said address portion for interesting packets comprises 8 entries.

10. The method for filtering packets as recited in claim 7, further comprising a step of storing said packet in a host memory selectively.

11. The method for filtering packets as recited in claim 7, further comprising a step of performing a hash operation on said destination address so as to look up a hash table to determine whether said packet is to be received.

12. The method for filtering packets as recited in claim 7, further comprising a step of examining a receive descriptor by a driver so as to identify whether said received packet is an interesting packet.

13. The method for filtering packets as recited in claim 12, wherein said receive descriptor comprises an interesting packet field, wherein said driver identifies whether said received packet is an interesting packet by examining said interesting packet field.

14. The method for filtering packets as recited in claim 7, further comprising a step of responding the result of said comparing step so as to generate a hit status.

15. The method for filtering packets as recited in claim 3, further comprising a step of encoding and outputting said hit status.

16. The method for filtering packets as recited in claim 3, further comprising a step of responding said hit status so as to update an interesting packet field of a corresponding receive descriptor of said packet.

17. A MAC (medium access control) controller, comprising:
a buffer, for receiving and storing a portion of a packet;
a content addressable memory, comprising an identifying circuit coupled to said buffer for storing a plurality of MAC addresses; and
a receive buffer; coupled to said buffer and said content addressable memory, so as to store said packet;
wherein said an identifying circuit compares a destination address in said packet and said plurality of MAC addresses of said content addressable memory, so as to determine whether said receive buffer should drop said packet.

18. The MAC controller as recited in claim 17, further comprising a hash operation circuit for performing a hash operation on said destination address so as to check with a hash table and to determine whether said receive buffer should drop said packet.

19. The MAC controller as recited in claim 17, wherein said content addressable memory comprises an address portion for interesting packets and an address portion for general packets; wherein said plurality of MAC addresses comprise a plurality of interesting packet addresses and a plurality of multicast addresses; and wherein said address portion for interesting packets is used for storing said plurality of interesting packet addresses and said address portion for general packets is used for storing said plurality of multicast addresses.

20. The MAC controller as recited in claim 17, wherein said identifying circuit generates a hit status signal according to the comparison result.
